(19) United States
(12) Patent Application Publication
(10) Pub. No.: US 2025/0320836 A1
(43) Pub. Date: Oct. 16, 2025

(54) VARIABLE COMPRESSION RATIO DEVICE

(71) Applicants: Reinaldo de Souza Barreto, São Paulo (BR); Almir Gonçalves Pereira, Juiz de Fora (BR); Paulo Roberto de Oliveira, Juiz de Fora (BR)

(72) Inventors: Almir Gonçalves Pereira, Juiz de Fora (BR); Paulo Roberto de Oliveira, Juiz de Fora (BR)

(21) Appl. No.: 19/235,447

(22) Filed: Jun. 11, 2025

Related U.S. Application Data
(63) Continuation of application No. 18/408,094, filed on Jan. 9, 2024, now Pat. No. 12,359,629.
Application No. 18/408,094 is a continuation of application No. 17/577,572, filed on Jan. 18, 2022, now Pat. No. 11,879,400.
Application No. 17/577,572 is a continuation-in-part of application No. PCT/BR2020/050281, filed on Jul. 22, 2020.

(30) Foreign Application Priority Data
Jul. 28, 2019 (BR) 102019015490-0
Apr. 7, 2020 (BR) 102020006998-5

(51) Int. Cl. F02D 15/02; F02B 75/04; F02D 15/04; F16C 3/28

(52) U.S. Cl. CPC F02D 15/02; F02B 75/047; F02B 75/048; F02D 15/04; F16C 3/28

(57) ABSTRACT

A rotation coupler for an internal combustion engine includes a ring gear configured to rotate about a first axis. The rotation coupler further includes an input pinion gear configured to transfer rotation of a crankshaft of the internal combustion engine to the ring gear to cause the ring gear to rotate about the first axis. The input pinion gear is eccentrically movable relative to the first axis. The rotation coupler further includes an output pinion gear configured to transfer rotation of the ring gear about the first axis to a flywheel of the internal combustion engine.

### FIGURES

In the following paragraphs, the Figures of this Patent “CRANKSHAFT COUPLING DEVICE APPLICABLE TO INTERNAL COMBUSTION ENGINES WITH VARIABLE COMPRESSION RATIO” will be listed, with a brief description of each and its parts, and additional information will be given in the Detailed Description of the Invention section.

FIG. 101: It shows, in section, a typical example of a common internal combustion engine with a fixed compression ratio, for the purpose of comparing the changes proposed in this patent, as follows: (101) the engine block; (102) the bottom of the engine block; (103) the engine head; (104) the valve camshaft assembly; (105) the crankcase cover; (106) the fuel mixture inlets or outlets; (107) the engine cylinder body; (108) the piston or plunger; (109) the piston connecting rod; (110) the piston axle; (111) the connecting rod head axle (journal); (112) the crankshaft axle; (113) the crankshaft bearing (yoke pin); (114) the crankshaft counterweight; (115) the combustion chamber; (116) the crankshaft shim. In (117), a delimitation indication was placed on a traditional engine, where the application of the present “CRANKSHAFT COUPLING DEVICE APPLICABLE TO INTERNAL COMBUSTION ENGINES WITH VARIABLE COMPRESSION RATIO” will be made.

FIG. 102: It shows, in section, two internal combustion engines, both with fixed compression ratios, where the combustion chambers can be seen, where their size exemplifies, in the first engine (A), a low compression ratio and in the second engine (B), the high compression ratio. The numerical indications are: (115A) combustion chamber with low compression ratio; (115b) combustion chamber with high compression ratio. The other numerical indications refer to the same parts mentioned in FIG. 101, which will have their purposes maintained.

FIG. 103: It highlights the moving internal parts of a typical internal combustion engine, for a better understanding of the subsequent inclusion of the “CRANKSHAFT COUPLING DEVICE APPLICABLE TO INTERNAL COMBUSTION ENGINES WITH VARIABLE COMPRESSION RATIO.” Such parts are mainly responsible for defining the compression ratio, that is, the pistons (108), next to the cylinders, (107) in FIG. 101, here not represented for separate viewing of the pistons (108), the connecting rods (109) and the crankshaft (112). The numerical references also correspond to the parts mentioned in FIG. 101, except the numbers (118), which is the connection flange (disc) of the crankshaft (112) with engine flywheel and the number (119), which is the connecting rod head, responsible for transmitting the movements of the pistons (108) to the crankshaft (112).

FIG. 104: It presents an internal combustion engine, with one of the possible applications of the “CRANKSHAFT COUPLING DEVICE APPLICABLE TO INTERNAL COMBUSTION ENGINES WITH VARIABLE COMPRESSION RATIO,” which is the subject of this Patent, already added to said engine. Here, solid half gears (124) were used, driven by intermediate gears (126), whose axle (127) is arranged next to and above the crankshaft (112), but other positions are also possible.

FIG. 105: It presents, separately, for better understanding, the “CRANKSHAFT COUPLING DEVICE APPLICABLE TO INTERNAL COMBUSTION ENGINES WITH VARIABLE COMPRESSION RATIO,” in the version of FIG. 104. In this Figure and FIG. 104, the solid half gears (124) can be seen. The electronic control unit (135) stands out, which controls the stepper motor (129), whose axle (130), connected to a worm screw (131), transmits the movements (turns or degrees) of this motor (129), through the gear (128) to the intermediate axle (127) and, through it, to the intermediate gears (126). Other elements that appear in this Figure and in FIG. 104 are: eccentrics (132) that moves the crankshaft (112) in translation in relation to the cylinder (17 in FIG. 101); the crankshaft (112); gears (120a and 120b) coupled on both sides of the crankshaft. A key feature is the coupling assemblies (120a, 120b, 121a, 121b, 123 and 133), innovative elements that allow the rotation of the crankshaft (112), even in translation, to be transformed simply into rotation on the axle (122) coupling to the motor camshaft (implied) and the drive shaft (134) of the engine flywheel's (implied) flange (118).

FIG. 106: An example of an internal combustion engine is seen, with the “CRANKSHAFT COUPLING DEVICE APPLICABLE TO INTERNAL COMBUSTION ENGINES WITH VARIABLE COMPRESSION RATIO,” which is the subject of this Patent, added to said engine, however, with the semi-gears (125) alternatively of the hollow type, where the axle (127), containing the intermediate gears (126), is also alternatively arranged below the crankshaft (112), meaning that its location can be in any position desired by the designer, according to their convenience and design needs.

FIG. 107: It shows, in highlight, the axle (127) of the intermediate gears (126), which drives the semi-gears (124) in FIG. 104 and 105 or (125) in FIG. 106. On the right, the assembly formed by the gear (128) with a worm screw (131), which leads the movement of the stepper motor (129 FIG. 106) to said axle (127) of the intermediate gears is seen. The stepper motor (129) may, under design, directly drive the axle (127).

FIG. 108: As main parts of the “CRANKSHAFT COUPLING DEVICE APPLICABLE TO INTERNAL COMBUSTION ENGINES WITH VARIABLE COMPRESSION RATIO,” this Figure presents the coupling assemblies (120a, 120b, 121a, 121b, 123 and 133), which convert the circular movements of rotation and translation of the crankshaft shaft (112) into rotation only, both on the shaft (134) that drives the engine flywheel's flange (118) and the gearbox (implied), and on the axle (122), which transmits rotation to the other engine control elements. Although, FIGS. 104, 105, 106, 108, 109, 110, 111, 112, 117 and 118 are referring to two coupling sets (120a, 120b, 121a, 121b, 123 and 133), there may be the use of only one coupling, as will be detailed in FIGS. 119, 120 and 121.

FIG. 109: This Figure shows, in section, four representations, A, B, C and D, where the actuation of the innovative coupling assemblies is shown, in three positions of the crankshaft (112), to change the compression ratio of the motor, wherein, in letter A, it is understood that the gears (120a and 120b) of the crankshaft (112 in FIGS. 104, 105, 106 and 108) are in the same position as the gear (123) of the axle connecting to the camshaft (122 of the same previous Figures) and the gear (133) (also of the previous Figures) of the shaft (134 in the cited Figures) connecting to the engine flywheel's (implied) flange (118 of the same cited Figures). In the other representations of this Figure, it can be observed that these same elements appear, in letter B, in the position of low compression ratio; in letter C, in the position of average compression ratio, and it can be noted that, in this case, there was a slight upward translation of the gears (120a and 120b) of the crankshaft (112), without effectively changing their rotation. In D, the crankshaft (112) and its associated gears (120a and 120b) are in the upper position, with accentuation of their translation. Although represented in their limit, lower and upper positions, the gears (120a and 120b) can be displaced only enough to achieve the objective of a given compression ratio.

FIG. 110: It presents two coupling assemblies (120a, 120b, 121a, 121b, 123 and 133), one at each end of the crankshaft (112), one of which drives the engine flywheel through its flange (118) and the other, which drives the camshaft (122) of the engine. As already mentioned, in other Figures and will be better explained in another section, there is also the alternative of using a single coupling assembly, connected to the crankshaft's (112) flange (118). In the present Figure it can be observed that the crankshaft (112) is in its lowest position, which will correspond, as will be further described in another section, to the lowest compression ratio.

FIG. 111: They are the same components of the coupling assembly of FIG. 110, with the difference that, here, the crankshaft (112) has undergone translation to an intermediate position, corresponding to a compression ratio different from high and low.

FIG. 112: Same as described in FIGS. 110 and 111, but the crankshaft (112) has undergone maximum translation and is now in a higher position, corresponding to a high compression ratio. Note that, in the three conditions (FIGS. 110, 111 and 112), only the gears (120a and 120b) of the crankshaft (112) change position, by translation, within the coupler (121a and 121b), without losing the ability to also transmit rotation.

FIG. 113: Highlights one of the variants of the half gears (124), mentioned in FIGS. 104 and 105. It is also identified the eccentric (132), in front and side view, responsible for the crankshaft (112) translation. An important design detail is the division of the eccentrics (132) into two parts, exactly in the middle of the inner and outer circles. Without this device, it would not be possible to house the intermediate eccentrics in the journal shims (shown in FIG. 116, item 138), in the middle of an entire crankshaft (112).

FIG. 114: In this Figure, the equivalent of FIG. 113 can be seen, but with the semi-gears (125), of the hollow type.

FIG. 115: C and D present the same engine, with the “CRANKSHAFT COUPLING DEVICE APPLICABLE TO INTERNAL COMBUSTION ENGINES WITH VARIABLE COMPRESSION RATIO,” for comparison, in two position conditions of the eccentrics (132), and in the left representation (C), the engine has the piston (108) in the upper dead point, but with low compression ratio, which is evident by the greater volume of the combustion chamber (115a). In the representation on the right (D), the same engine also has the piston (108) in its highest position, but with a high compression ratio, which can be seen by the smaller volume of the combustion chamber (115b). Some differences in the “CRANKSHAFT COUPLING DEVICE APPLICABLE TO INTERNAL COMBUSTION ENGINES WITH VARIABLE COMPRESSION RATIO” can also be identified, where, also in feasible alternative, the semi-gears have been replaced, by complete gears (136), that is, teeth in the 360 degrees; the axle (127) of intermediate gears (126) has been installed in an upper and right position (in C and D) of the crankshaft (112), indicating that its location is subject to a decision of the designer.

FIG. 116: This Figure shows, in detail, for better understanding, the application of the “CRANKSHAFT COUPLING DEVICE APPLICABLE TO INTERNAL COMBUSTION ENGINES WITH VARIABLE COMPRESSION RATIO,” with an assembly equivalent to the solution adopted in FIG. 115, where the stepper motor was installed at a level above the axle (127) of the gears (128), which drive, through the axle (130) and the worm screw (131), the master gears (136) which, in turn, promotes the movement of the eccentrics (132). These eccentrics (132) move, through a small turn, the crankshaft (112). One or more gears (120a and 120b) is associated with the crankshaft (112) on one or both ends of the crankshaft (112). These gears transmit rotation to the gears (123 of FIG. 112) connected to the axle (122 of FIG. 112) of the motor drive and to the other associated external elements (not shown) and to the gear (133, FIG. 112) of the shaft (134, FIG. 112) which will drive, in turn, the engine flywheel's flange (118). In this FIG. 116, the part of the support (137) (housed in the engine block) of the eccentric assembly (132), the crankshaft (112), with its gears (120a and 120b), the shim (138) of the eccentric (132) and its fixing screws (139) can still be identified. The fact that this assembly presents a position different from those presented in FIGS. 104), (105), (106) and (116) proves, once again, the versatility of the solution offered by the “CRANKSHAFT COUPLING DEVICE APPLICABLE TO INTERNAL COMBUSTION ENGINES WITH VARIABLE COMPRESSION RATIO.”

FIG. 117: In this Figure, within the same inventive concept, another alternative for building the coupler (121a and 121b), where the gears (120a and 120b) of the crankshaft (112) are mounted side by side through the coupler (121a′ and 121b′) is seen. This side-by-side assembly reduces the depth in relation to the initially proposed coupler (121a and 121b), however, there will be a need for a larger diameter for the internal gear that forms this coupler, which may not be, in some cases, advantageous. To clarify some details: there is only one gear (120a or 120b), however, it is represented, in the illustration on the left, in 3 (three) of the many alternatives necessary to promote the low compression ratio (position 120-1), the average compression ratio (position 120-II) and the high compression ratio (position 120-III) or any intermediate compression ratio. On the other hand, the three positions are intentionally exaggerated, simply for better visualization, since the variation of the crankshaft (112) between the low and high compression ratio is a few millimeters, which shows that the translation of the gears (120a and 120b) within (121a and 121b) will be small. A probable disadvantage of this assembly, in most cases, will be that the determination of the diameter (g) of the eccentric (132) may affect the average diameter of the coupling gear (121a′ and 121b′) or vice versa, depending on the designer, and may impose exaggerated diameters for the eccentric (132).

FIG. 118: It presents another alternative, showing an internal combustion engine, where the “CRANKSHAFT COUPLING DEVICE APPLICABLE TO INTERNAL COMBUSTION ENGINES WITH VARIABLE COMPRESSION RATIO,” which is the subject of this Patent, is added to said engine, however, with the translation of the crankshaft (112) being provided by the rod (145) fixed to the axle (148) of the stepper motor (149) through the fixed joint (147). This rod (145) moves the moving rod (144), through the joint (146). The rod (144) drives the axle (142) through the movable joint (143). As in this axle (142) the rods (140) of the eccentrics (132) are articulated, the movements started in the stepper motor (149), controlled by the electronic control unit (150), will start to move the eccentrics (132), imposing changes in the distance from the crankshaft (112) to the top of the cylinders (18).

Regarding the various Figures, it should be noted that the coupling assemblies could eventually be replaced by planetary gears, chains or even “joints” of the Cardan, Schmidt, Oldham or homokinetic type, which would allow the movement of the crankshaft (112) and, at the same time, maintain the couplings of the gears (120a and 120b) thereof with the camshafts (122 and 123) and coupling to the engine flywheel's flange (118). However, in such circumstances, there will be an excessive increase in the distance between the crankshaft (112) and the outer axles mentioned (122 and 123), in addition to increasing the number of parts necessary for coupling, which may become too fragile for the purpose of transmitting the effective torque of the motor. Planetary or concentric gears would also be possible to be adopted in this patent; however, despite reducing the distance from the crankshaft (112) to the external axes (122 and 123), they would require a substantial increase in the lateral or radial space and, consequently, of all eccentrics (132) of the crankshaft (112), as shown in FIG. 117). These considerations confirm that the proposed coupling solution proves to be the most suitable and simple in the implementation of this Patent.

FIG. 119: In this Patent Application, “CRANKSHAFT COUPLING DEVICE APPLICABLE TO INTERNAL COMBUSTION ENGINES WITH VARIABLE COMPRESSION RATIO,” it is intended to address the maximum of possibilities envisaged, in the same inventive concept, that enable the achievement thereof. Thus, in this Figure, there is a very interesting alternative, as it is simpler and more economical, as it uses only one coupling set (120b and 121c), a variant of the other coupling sets shown in this Specification. This single coupling assembly is attached directly to the engine flywheel's (150) flange (118). In this way, when the crankshaft (112) makes the rotation movements, promoted by the Connecting Rods (109) and translation, promoted by the eccentrics (132), the coupling assembly will receive the rotation and translation movements of the crankshaft (112), through the gear (120b), located at the end of the crankshaft (112), and transmit, through the gear (121c), simply the rotation movement to the engine flywheel (150). On the opposite side of the crankshaft (112), in the part that drives the camshaft (154) of the valves, a turnbuckle (153) can be added to the toothed belt (152), in a position such that the synchronism between the crankshaft (112) and the camshaft (154) is maintained. The pulley (151), connected to the end of the crankshaft (112), is responsible for transmitting its rotational movements to the toothed belt (152).

FIG. 120: The alternative shown in FIG. 119 is shown in more detail, showing the coupling assembly (120b and 121c) incorporated in the engine flywheel's (150) flange (118), the gear (120b) incorporated in the tip of the crankshaft (112), the pulley (151) of the toothed belt (152 in FIG. 119) and the eccentrics (132). The illustration at the bottom serves to give a better visualization of this application of the “CRANKSHAFT COUPLING DEVICE APPLICABLE TO INTERNAL COMBUSTION ENGINES WITH VARIABLE COMPRESSION RATIO.”

The arrows indicate the locations where the eccentrics (132) will be housed in the crankshaft (112). The operation of the assembly has already been detailed in the description of FIG. 119. As an alternative, the eccentrics (132) of the ends of the crankshaft (112) can be built as a whole, without bipartition, as their insertions in the crankshaft (132) can be made laterally, before placing the crankshaft (132) in the engine.

FIG. 121: This Figure refers to a variant of that shown in FIGS. 119 and 120, where the position of the gears (120b with 121c) was reversed in the coupling assembly. In this case, this gear (120b) was connected directly to the engine flywheel's (150) flange (118) and the gear (121c), was connected to the end of the crankshaft (112), directly or through an adapter. As for the operation, it is enough to observe that, now, the element that will simultaneously accompany the rotation and translation movements of the crankshaft (112) is the gear with internal teeth (121c), while the gear with external teeth (120b) performs rotation movement only, which will be imposed on the engine flywheel (150), through the flange (118).

FIG. 122: Regarding FIGS. 119, 120 and 121, it is worth noting that, for case of implementation thereof, the reasoning of teeth between the gear (120b) and the gear (121c) should preferably be integer, for example, of 1:2, 1:3, etc. As shown in this Figure, if gear (120b) has, for example, 9 teeth, gear (121c) will have 18 teeth (or integer multiple of 9). This proposition intends to promote a known, whole, and fixed turning ratio, which is easily related to the rotating elements of the engine, for example, the phonic wheel (implied), responsible for adjusting the engine point, if it is on the side of the engine flywheel (150). Thus, taking as an example the assembly of FIGS. 119 and 120, the 1:2 ratio between the gear (120b) and the gear (121c) means that, for each rotation of the crankshaft (112) and, consequently, of the gear (120b), there will be a half turn in the gear (121c). If the assembly is the one explained in FIG. 21, where the gear (120b) is connected to the engine flywheel's (150) flange (118), the suggested ratio between them will be 2:1, that is, for each rotation of the gear (121c) and, as a consequence, of the crankshaft (112), to which it is connected, it will impose 2 full turns on the gear (120b) and the engine flywheel (150).

FIG. 123: In this Figure, a variant of FIG. 119 is presented, whose main difference is that a second coupling assembly is used, installed at the end of the crankshaft (112) opposite the end where the engine flywheel (150) is, formed by the following parts: crankshaft gear (120b′) and coupling gear (121c′), directly associated with the toothed pulley (151), without the need for the turnbuckle (153) correcting the translations of the crankshaft (112), as in FIG. 119, which makes the engine, externally, in this version, similar to current engines.

FIG. 124: This Figure has, for FIG. 123, the same purpose as FIG. 120 has for FIG. 119, that is: to show, in more detail, the new alternative presented in FIG. 123, with a highlight where you see two alternatives for said end of the crankshaft (112), where it connects to the engine controls. At the end (C) of the crankshaft (112), both the coupling assembly shown on the lens (A) and the coupling assembly shown on the lens (B) can be installed at the designer's choice. The operation of these sets can be well understood by referring to the explanations referring to FIGS. 119, 120 and 121.

FIG. 125: This Figure also has, for FIG. 123, the same purpose that FIG. 121 has for FIG. 119, that is: to show, in more detail, the new alternative presented in FIG. 123, with the highlight where you see two alternatives for said end of the crankshaft (112), where it connects to the engine controls. Similarly to the one mentioned in FIG. 124, at the end (C) of the crankshaft (112), both the coupling assembly shown in lens (A) and the coupling assembly shown in lens (B) can be installed at the designer's choice. The operation of these sets can be well understood by also referring to the explanations referring to FIGS. 119, 120 and 121.

Also, it is worth mentioning that it is essential that there is an adequate design, for each engine, that contemplates the compensation of any differences in angle in the rotation of the crankshaft (112) in relation to the rotation of the camshaft (154), so that the timing and, consequently, the efficiency of the engine set is not impaired. However, such compensation may be better resolved by the motor electronics unit itself.

### CONSIDERATIONS ON THE FEASIBILITY OF THE INVENTION

In order to enable the execution of this patent proposal, “CRANKSHAFT COUPLING DEVICE APPLICABLE TO INTERNAL COMBUSTION ENGINES WITH VARIABLE COMPRESSION RATIO,” making it interesting to the automotive industry, whether of motor vehicles, motorcycles or stationary engines and all other engines derived from these applications, the objective here was, within the same inventive concept, to show effective, economical, easy to implement and maintain solutions. To this end, this new design proposal offered by this patent, “CRANKSHAFT COUPLING DEVICE APPLICABLE TO INTERNAL COMBUSTION ENGINES WITH VARIABLE COMPRESSION RATIO,” may be included in the new designs of internal combustion engines, which allows the variation of the compression ratio of these engines. For its simplicity, as presented in this Specification, several designs of various current engines may benefit from this Patent, with slight changes thereto. It is also possible that the coupling device focused on this Patent may be included in some of the engines already available; in this case, such inclusion may be made through adaptive modules (kits) that the market may eventually offer, as long as it considers them to be mechanically and economically viable and advantageous.

The solution proposed in this Patent, “CRANKSHAFT COUPLING DEVICE APPLICABLE TO INTERNAL COMBUSTION ENGINES WITH VARIABLE COMPRESSION RATIO,” basically consists of changing the distance between the crankshaft (also known as crank shaft or connecting-rod shaft) (112) and the top of the cylinders, keeping the size of the connecting rods (109) and crankshaft (112) constant. This variation in the crankshaft's position (112) will be achieved through an additional bearing, with an eccentric body (132) that, varied by the rotation imposed by a stepper motor (135), associated with a gear (126) axle (127), drives the main gears (124 or 125) connected to the eccentric bearing (132), causing the piston (108) to be displaced from its position, allowing to change the minimum or compressed volume of the cylinder (107). The variations imposed on the compression ratio will be controlled by an electronic control unit (135), which may be the same used for the general control of the engine, as long as it also allows the control of this device. In the eventual adaptation of the device detailed herein, it may be necessary to provide an exclusive electronic center for the device. But the innovative detail consists of the mechanism that makes the perfect coupling of the variations of translation and rotation, imposed on the crankshaft (112), that is, the coupling assembly, (which, within the same inventive concept, can be made possible in various embodiments), transmitting them to the external elements of the engine, the camshaft and the engine flywheel (150), solely as rotational movements, similar to what occurs in a conventional engine.

### DETAILED DESCRIPTION OF THE INVENTION

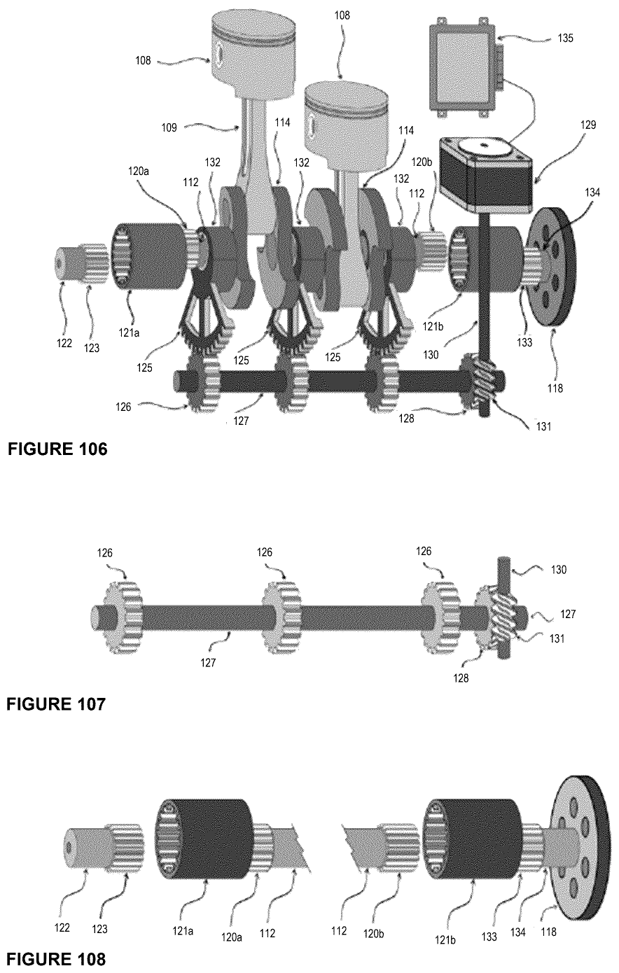

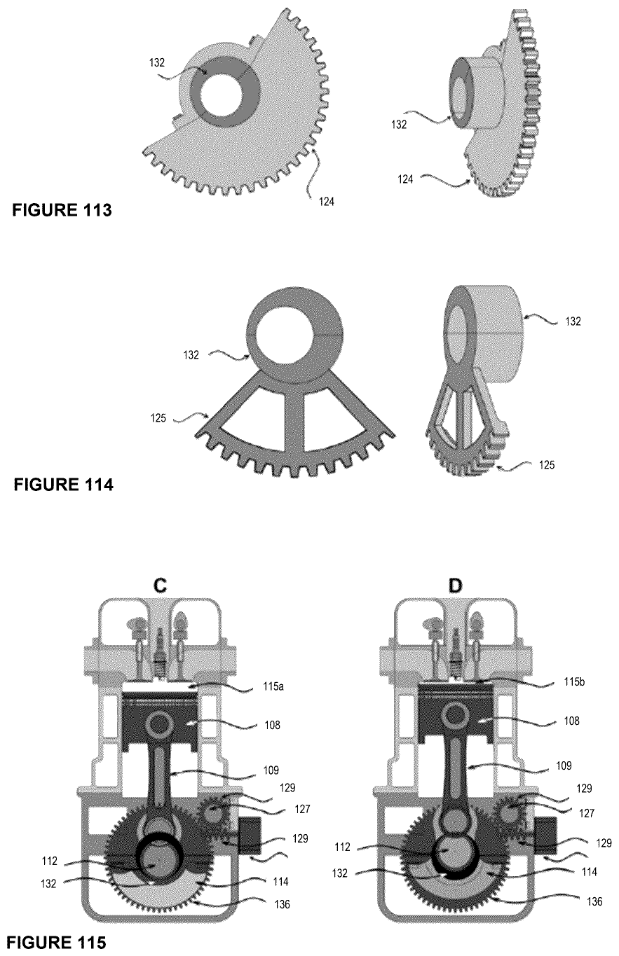

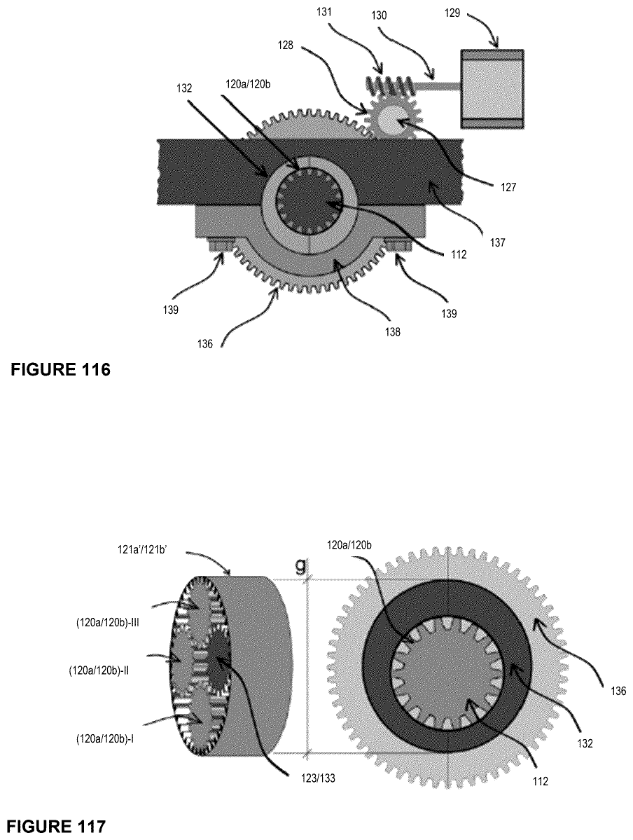

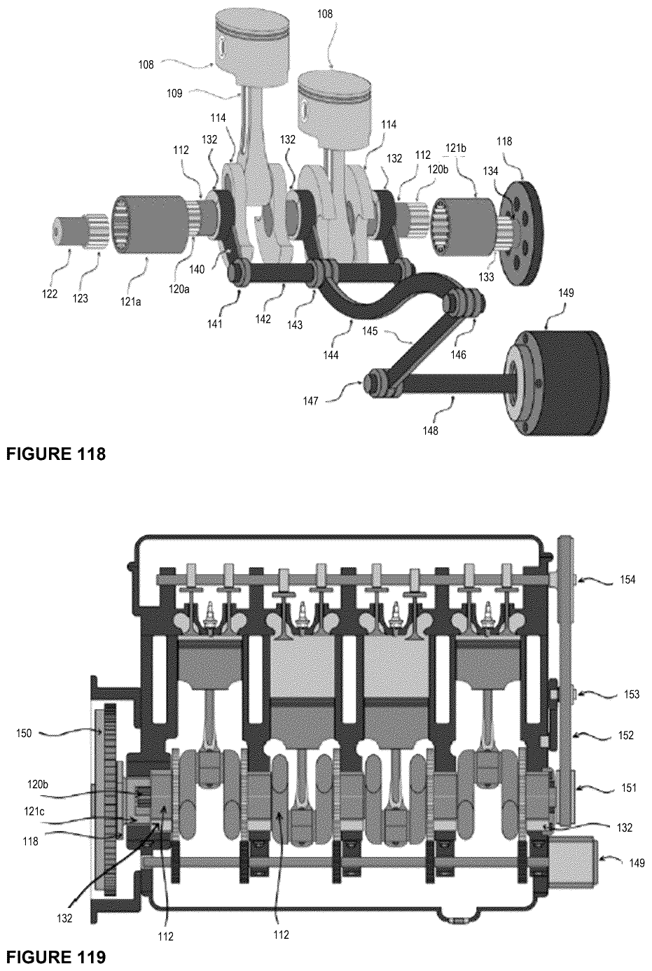

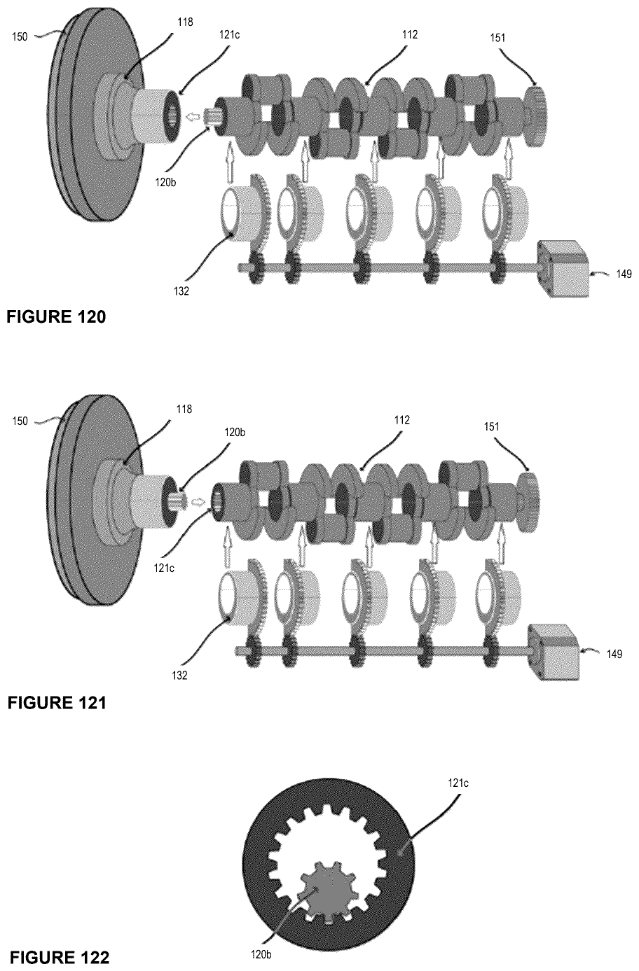

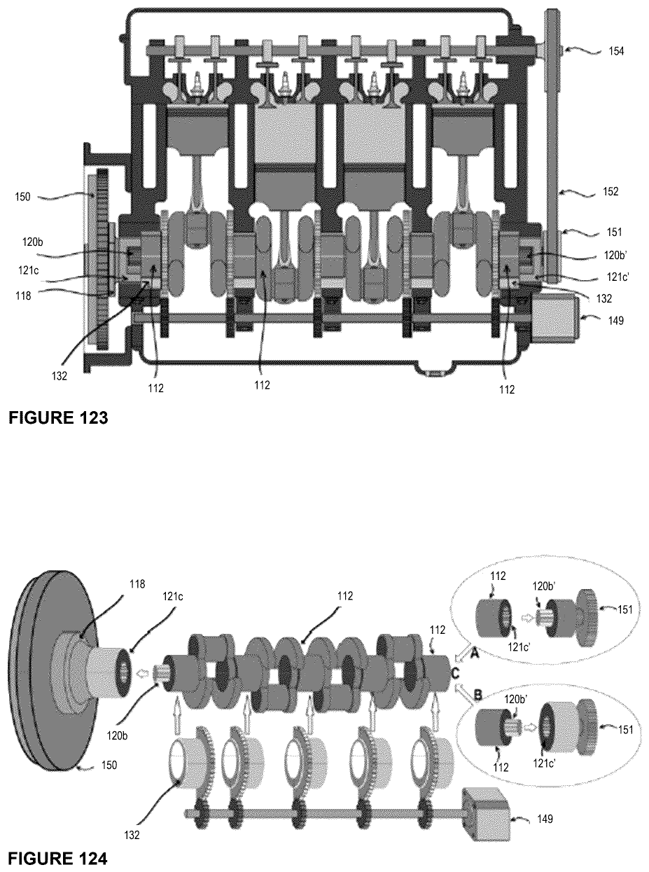

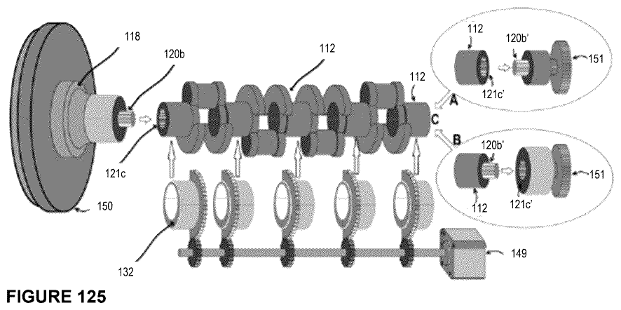

Referring to FIGS. 104, 105, 106, 115, 116, 118, 119, 120, 121, 123, 124 and 125, it appears that the “CRANKSHAFT COUPLING DEVICE APPLICABLE TO INTERNAL COMBUSTION ENGINES WITH VARIABLE COMPRESSION RATIO” consists, in essence, of a set of mechanical, electrical and electronic parts and accessories that, combined, promote the raising or lowering of the crankshaft (112), which, in turn, will change the distance from the piston (108) to the top of the cylinder (107), through the connecting rod (109). As a result, there is a change in the volume of the combustion chamber (115a and 115b), imposing changes in the compression ratio of the engine (FIG. 115a and FIG. 115b) to which the device is associated. For the crankshaft (112) to have its position changed, it is supported on eccentrics (132), which are moved by complete (136 in FIG. 115) or partial (that is, semi gears) massive (124 in FIG. 113) or hollow (135 in FIG. 114) gears, or rods (FIG. 118). Driving these gears associated with the eccentrics (132) we have other intermediate gears (126), fixed to an axle (127) responsible for joining as many gears as there are eccentrics (132). At one end of this axle (127) is optionally fixed a gear (128) that drives the axle (127), such gear being also optionally driven by a worm screw (or worm gear) (131). In turn, this worm screw (131) is attached to an axle shaft (130), an extension of the axle of a stepper motor (129). The purpose of this stepper motor (129) is to generate the rotation movements at exact angles, determined by an electronic control unit (135), programmed to determine, through the gears and associated axes, the exact positioning point of the crankshaft (112) to produce, in the combustion chamber (115a or 115b), the compression ratio most suitable for the fuel or fuel mixture used in the internal combustion engine, depending on the analysis of the various engine sensors and their parameters, in order to obtain the best efficiency thereof. With this, the internal combustion engine is operating within the best possible characteristics with the correct compression ratio.

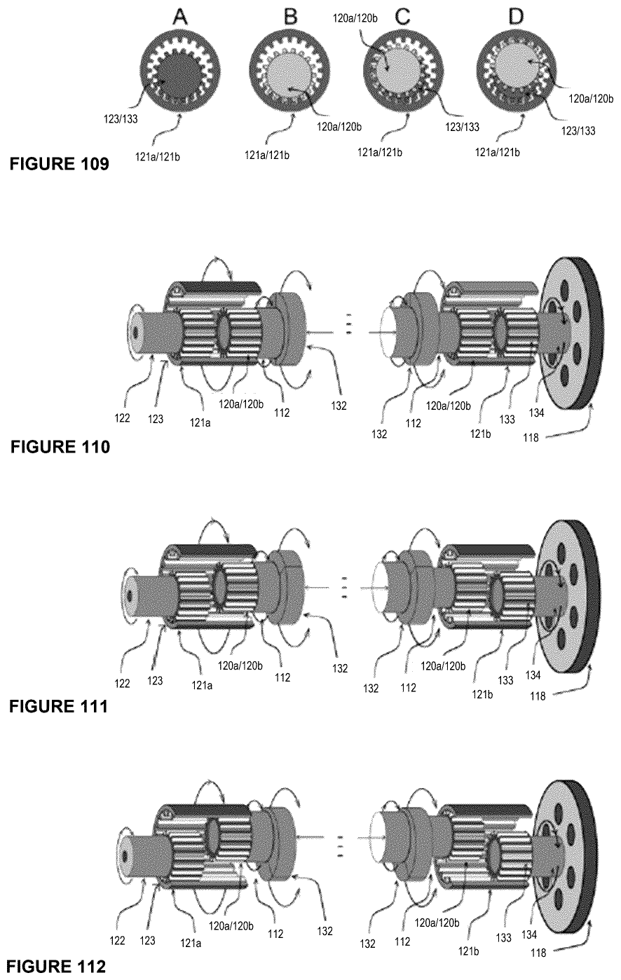

The most important, innovative part and focus of this Patent is the coupling assembly or coupling assemblies that, through two types of gears each, the largest type, with internal teeth, and the smallest, with external teeth, transform the rotational and translational movements of the crankshaft (112) only in rotation, resulting in that, on the outside, this internal combustion engine works similarly to a common engine, which has not incorporated therein, the “CRANKSHAFT COUPLING DEVICE APPLICABLE TO INTERNAL COMBUSTION ENGINES WITH VARIABLE COMPRESSION RATIO.” FIGS. 105 and 106, 108 to 112, 117 to 125 show these types of gears with inner and outer teeth, essential parts of the coupling assemblies.

The coupling assembly, always within the same inventive concept, whose function is to transform the rotational and translational movements of the crankshaft (112) only into rotational movement, can be implemented in various ways, as presented in this Specification, in many other possible ones, namely, a) coupling assembly comprised of an internal gear cylinder (121a and 121b), in pairs, with gear associated with each side of the crankshaft (112)—in this case, the gears with external teeth (133 and 123) are connected to the crankshaft (112), one at each end of this shaft (112) and also the external gears belonging to the axles (134 and 122), connected, respectively, to the engine flywheel's (150) flange (118) and to the axle (122) connecting to the external controls of the motor; b) coupling set comprised of a single internal gear cylinder (121a or 121b), only on the side of the crankshaft (112) where the engine flywheel's (150) flange (118) is located—on the opposite side of the crankshaft (112), there is the current sets of toothed pulley (151), which transmit the rotational movements to the axle of the motor control [in this case, a turnbuckle element (153) of FIG. 119, properly assembled, will eliminate the variations of the translations of the crankshaft (112)]; c) coupling assembly comprised of gear with internal teeth (121c of FIGS. 119 and 120), as part of the engine flywheel's (150) flange (118)—in this case, there is only one gear with external teeth (120b), associated with the crankshaft (112) [in this alternative there will also be the tender of a turnbuckle (153), with the same purpose mentioned above]; d) coupling assembly as a variant of the form mentioned in (a), the gear (121c of FIG. 121) is part of the crankshaft (112)—on the opposite side of the crankshaft (112) is the toothed pulley (151), together with the turnbuckle (153), with the same purpose as mentioned in (b) and (c), in this paragraph; d) coupling assembly designed with varied combinations of external and internal gears, incorporated in the engine flywheel's (150) flange (118) or incorporated in the crankshaft (112), as is detailed in FIGS. 121, 123, 124 and 125.

Based on the same inventive concept, FIG. 118 presents another solution, which is to change, through rods and not gears, the distance from the crankshaft (112) to the top of the cylinder (17), where the combustion chamber (115) is located, and transform the rotation and translation movements of the crankshaft (112) and its associated gears (120a and 120b), through the coupling assemblies (121a, 121b), with the alternatives described in the previous paragraph, in rotation-only movements, to be transferred to the gears (123 and 133), which, respectively, are joined to the axles (122) of the external motor control and (134) of the engine flywheel's flange. This other solution or invention does not make use of the gears (124, 125, 126, 128 and 131) and other associated components (127, 131). The set of new components is detailed below: the stepper motor (149), under the command of the electronic command center (150) that promotes a rotation of the axle (148), in degrees defined by the aforementioned center (150). Attached to the axle (148), through a fixed (147), there is a rod (145), which transfers the movement of the axle (148) of the motor (149) to an articulated joint (146), which causes the movement in another articulated rod (144) at both ends which, in turn, move, through the articulated joint (143), the axle (142). This axle (142), fixed to the rods (140) will rotate the eccentrics (132), as it is fixed to them. As seen in FIGS. 104, 105, 106 and 115), the rotation of the eccentrics (132) will cause the crankshaft (112) to have its distance changed, which will cause the distance from the piston (108) and relation to the top of the cylinder (107) to also be changed, imposing on the combustion chambers (115) a change in their volume, resulting in a variation in the compression ratio, which is the main objective of this patent “CRANKSHAFT COUPLING DEVICE APPLICABLE TO INTERNAL COMBUSTION ENGINES WITH VARIABLE COMPRESSION RATIO.” Here the couplings (121a and 121b) are also an indispensable part of the device. As an additional alternative of this type of drive (by rods), the coupling assemblies may also be incorporated in the flange (118) of the crankshaft (150) and the toothed pulley (151), thus eliminating, in each coupling assembly, one of the gears with external teeth.

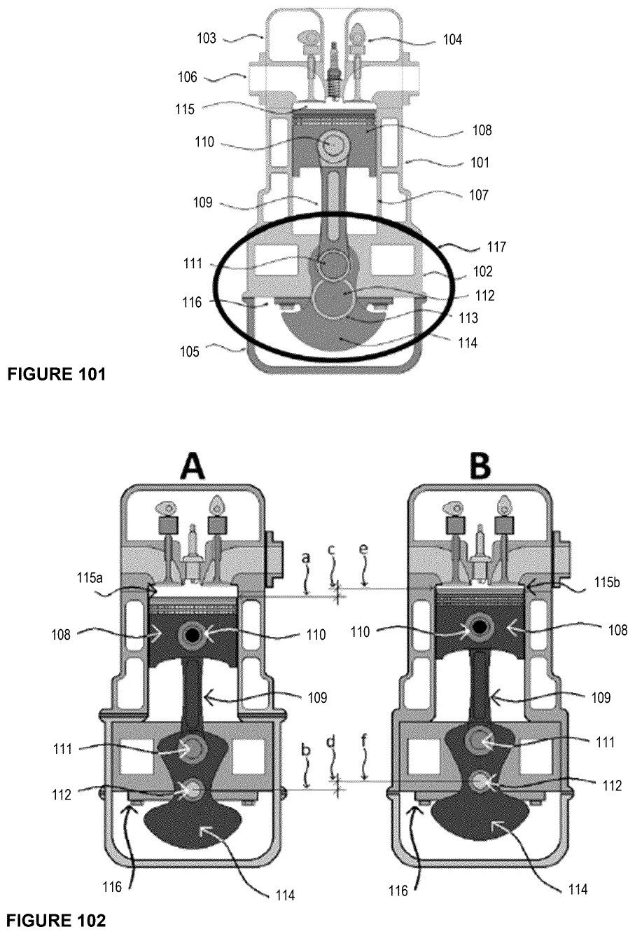

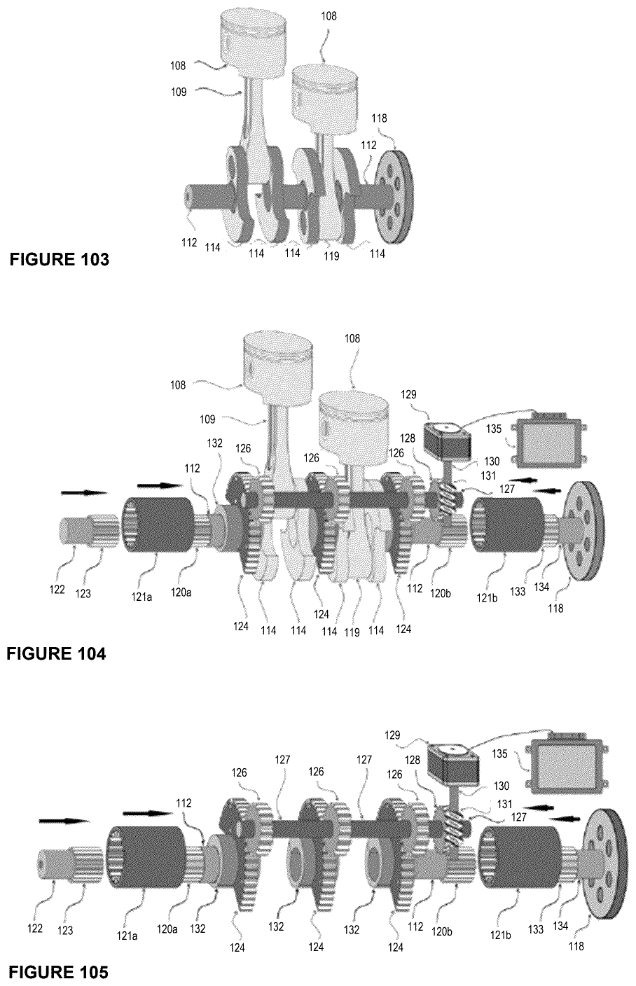

Seeking to cover the maximum applications of the inventive concept defended herein, that is, to vary the compression ratio of the cylinders of internal combustion engines by varying the distance between the crankshaft (112) and the top (TDC—top dead Center) of the cylinders (17 of FIG. 101) using several eccentrics (132), transferring the rotational movements (normal in all crankshafts) and circular translation (exclusive of the present device) through one or more appropriate coupling mechanisms, herein called the coupling assembly or coupling assemblies, they are presented in various versions (121a, 120a, 123, 121b, 120b and 133 of FIGS. 104, 105, 106, 108, 109, 110, 111, 112, 116, 117 and 118; 120b and 121c of FIGS. 119, 120, 121 and 122; 120b, 120b′, 121c and 121c′ of FIGS. 123, 124 and 125). Another denomination for this coupling mechanism may be coupling gear assembly, formed by inner and outer gears.

In order to further reduce the complexity, number of parts, maintenance and dimensions in the implementation of the “CRANKSHAFT COUPLING DEVICE APPLICABLE TO INTERNAL COMBUSTION ENGINES WITH VARIABLE COMPRESSION RATIO,” it is observed in FIGS. 120, 121, 123, 124 and 125, proposals for insertion of the coupling assemblies directly in the assemblies formed by the engine flywheel's (150) flange (118) and the pulley (151) of the camshaft (implied). Possibly, these are the alternatives to be preferred by the designers and maintenance mechanics, due to the fact that they can, in this way, achieve the same objectives with a smaller number of parts.

### Additional Comments on the Invention

Without exhausting the applicability of this patent, “CRANKSHAFT COUPLING DEVICE APPLICABLE TO INTERNAL COMBUSTION ENGINES WITH VARIABLE COMPRESSION RATIO,” there is, for example, the alternative of, before starting the engine, placing the compression ratio in the lowest position allowed by the assembly, resulting in less opposition to the movement imposed by the starter engine, as the internal combustion engine is looser, freer. Soon after the engine “fires up” (starts), the combustion rate can be reset to the optimal value at the desired speed. This alternative will allow more economical starters, in addition to reducing the initial shake while the internal combustion engine has not “fired up,” that is, it has not started to run on its own.

Another common condition is the need of changing the compression ratio when the vehicle engine is at varying speeds, accelerating or decelerating, with single fuel, for example, common, additive gasoline, common or additive ethanol (alcohol), natural gas, diesel, biodiesel, etc., or with the permitted blends of the aforementioned fuels. With this, this Patent “CRANKSHAFT COUPLING DEVICE APPLICABLE TO INTERNAL COMBUSTION ENGINES WITH VARIABLE COMPRESSION RATIO,” by providing a rational solution to manage and change the compression ratio of internal combustion engines, will favor the improvement of the efficiency of these engines in any conditions, with the consequent reduction of fuel consumption and environmental pollution, reduction of the size and weight of the engines as a function of greater power in smaller volumes, allowing the manufacturing of equivalent-power, lighter and cheaper engines, with the inclusion of the present device and, even so, more economical and less pollutants.

An important feature of the “CRANKSHAFT COUPLING DEVICE APPLICABLE TO INTERNAL COMBUSTION ENGINES WITH VARIABLE COMPRESSION RATIO” in relation to all other known technological proposals that intend to allow the variation of the compression ratio, is not to have moving parts associated with the mobile power components of the internal combustion engine, such as crankshaft (112), connecting rods (109) and pistons (108), except for the movements of the couplings, thus reducing wear and static and dynamic weights on the engine.

Regarding the application of “CRANKSHAFT COUPLING DEVICE APPLICABLE TO INTERNAL COMBUSTION ENGINES WITH VARIABLE COMPRESSION RATIO” in engines already in use or available designs, it may be offered, in any of the versions presented in this Specification, in the form of adaptive sets (kits), by the companies that supply auto parts, in specific models for each type of engine, previously evaluating the mechanical, economic and market feasibility. Of course, in this case, an electronic control unit specific to the kit must be provided, which works from the original electronic control unit of the vehicle, or a complete replacement of the original control unit must be offered.

What is claimed is:

1. A rotation coupler for an internal combustion engine, the rotation coupler comprising:
a ring gear configured to rotate about a first axis;
an input pinion gear configured to transfer rotation of a crankshaft of the internal combustion engine to the ring gear to cause the ring gear to rotate about the first axis, wherein the input pinion gear is eccentrically movable relative to the first axis; and
an output pinion gear configured to transfer rotation of the ring gear about the first axis to a flywheel of the internal combustion engine.

2. The rotation coupler of claim 1, wherein the input pinion gear is configured to rotate about a second axis, and wherein the second axis is eccentrically movable relative to the first axis based on a position of the crankshaft.

3. The rotation coupler of claim 2, wherein eccentric movement of the second axis relative to the first axis corresponds with eccentric movement of the crankshaft associated with a variable compression ratio of the internal combustion engine.

4. The rotation coupler of claim 1, wherein the output pinion gear is configured to rotate about a third axis, and wherein the third axis is fixed relative to the first axis.

5. The rotation coupler of claim 1, wherein the input pinion gear and the output pinion gear have a same diameter so that the output pinion gear rotates at a same angular velocity as the input pinion gear.

6. The rotation coupler of claim 1, wherein the ring gear comprises a plurality of inner teeth, wherein the input pinion gear comprises a first plurality of outer teeth, wherein the output pinion gear comprises a second plurality of outer teeth, and wherein the first plurality of outer teeth and the second plurality of outer teeth are configured to mesh with the plurality of inner teeth.

7. The rotation coupler of claim 1, wherein the input pinion gear and the output pinion gear are configured to rotate within the ring gear.

8. An internal combustion engine, comprising:
a crankshaft configured to rotate about a first axis, wherein the first axis is eccentrically movable relative to a second axis;
a flywheel configured to rotate about a third axis; and
a rotation coupler configured to transfer rotation of the crankshaft about the first axis to the flywheel, wherein the rotation coupler comprises:
a ring gear configured to rotate about the second axis;
an input gear coupled with the crankshaft and configured to rotate about the first axis, wherein the input gear is further configured to transfer the rotation of the crankshaft to the ring gear to cause the ring gear to rotate about the second axis; and
an output gear coupled with the flywheel and configured to rotate about the third axis, wherein the output gear is further configured to transfer rotation of the ring gear about the second axis to the flywheel.

9. The internal combustion engine of claim 8, wherein the input gear is eccentrically movable relative to the second axis together with the crankshaft.

10. The internal combustion engine of claim 8, wherein eccentric movement of the first axis relative to the second axis corresponds with eccentric movement of the crankshaft associated with a variable compression ratio of the internal combustion engine.

11. The internal combustion engine of claim 8, wherein the third axis is fixed relative to the second axis.

12. The internal combustion engine of claim 8, wherein the input gear and the output gear have a same diameter so that the output gear rotates at a same angular velocity as the input gear.

13. The internal combustion engine of claim 8, wherein the ring gear comprises a plurality of inner teeth, wherein the input gear comprises a first plurality of outer teeth, wherein the output gear comprises a second plurality of outer teeth, and wherein the first plurality of outer teeth and the second plurality of outer teeth are configured to mesh with the plurality of inner teeth.

14. The internal combustion engine of claim 8, wherein the input gear and the output gear are configured to rotate within the ring gear.

15. A device, comprising:
an input gear configured to rotate about a first axis;
a ring gear configured to rotate about a second axis based on rotation of the input gear about the first axis, wherein the first axis is eccentrically movable relative to the second axis; and
an output gear configured to rotate about a third axis based on rotation of the ring gear about the second axis.

16. The device of claim 15, wherein the input gear is configured to couple with a crankshaft of an internal combustion engine, and wherein eccentric movement of the first axis relative to the second axis corresponds with eccentric movement of the crankshaft associated with a variable compression ratio of the internal combustion engine.

17. The device of claim 16, wherein the output gear is configured to couple with a flywheel of the internal combustion engine.

18. The device of claim 15, wherein the third axis is fixed relative to the second axis.

19. The device of claim 15, wherein the input gear and the output gear have a same diameter so that the output gear rotates at a same angular velocity as the input gear.

20. The device of claim 15, wherein the ring gear comprises a plurality of inner teeth, wherein the input gear comprises a first plurality of outer teeth, wherein the output gear comprises a second plurality of outer teeth, and wherein the first plurality of outer teeth and the second plurality of outer teeth are configured to mesh with the plurality of inner teeth.
